(19) United States
(12) Patent Application Publication
(10) Pub. No.: US 2020/0277811 A1
(43) Pub. Date: Sep. 3, 2020

(54) VEHICLE DOOR EXTERIOR HANDLE DEVICE

(71) Applicant: KABUSHIKI KAISHA HONDA LOCK, MIYAZAKI-SHI, MIYAZAKI (JP)

(72) Inventors: Takahiro YAMADA, MIYAZAKI-SHI, MIYAZAKI (JP); Tomoyuki KUKITA, MIYAZAKI-SHI, MIYAZAKI (JP)

(21) Appl. No.: 16/479,741

(22) PCT Filed: Apr. 13, 2018
(86) PCT No.: PCT/JP2018/015491

§ 371 Date: Jul. 22, 2019

(30) Foreign Application Priority Data
Apr. 14, 2017 (JP) 2017-080390

(51) Int. Cl. E05B 79/06; B60J 5/04; E05B 85/16

(52) U.S. Cl. CPC E05B 79/06; B60J 5/0468; E05Y 2900/531; E05B 85/16; B60J 5/0415

(57) ABSTRACT

A vehicle door exterior handle device is provided in which insertion of a handle lever into an opening of the vehicle door is disabled at the non-actuated position but is allowed at the actuated position when a handle base having the handle lever in a state of being operatively linked to a linking arm part of the exterior handle is attached to the vehicle door, wherein a provisional holding member is mounted on the handle lever, the provisional holding member being capable of rotating around an axis parallel to a pivot axis of the handle lever, and an engagement portion is provided on the provisional holding member, the engagement portion being engaged with a latching part provided on the handle base when the handle lever is at the actuated position. This maintains the exterior handle at a door opened position for placing the handle lever into the actuated position.

### TECHNICAL FIELD

The present invention relates to a vehicle door exterior handle device in which a handle base having part thereof inserted into an outer panel of a vehicle door through an opening provided in the outer panel blocks the opening and is fixed to the vehicle door, a linking arm part provided on an exterior handle that enables a door opening operation outside the outer panel is inserted into an insertion hole provided in the handle base, the linking arm part being capable of moving between a non-operated position when the exterior handle is in a non-operated state and a door opened position when the exterior handle is in a door opening completed state, a handle lever operatively linked to the linking arm part is supported on the handle base while being capable of pivoting between a non-actuated position corresponding to the non-operated position of the linking arm part and an actuated position corresponding to the door opened position of the linking arm part, the handle lever being resiliently urged toward the non-actuated position side, and insertion of the handle lever into the opening is disabled at the non-actuated position but is allowed at the actuated position when the handle base having attached thereto the handle lever in a state of being operatively linked to the linking arm part is attached to the vehicle door.

### BACKGROUND ART

When an exterior handle is attached to a vehicle door, a handle base having attached thereto a handle lever operatively linked to a linking arm part of the exterior handle is fixed to an outer panel, the handle lever at a non-actuated position cannot be inserted through an opening provided in the outer panel, and insertion into the opening becomes possible by operating the exterior handle to a door opened position to thus put the handle lever into an actuated position. Because of this, conventionally a worker carries out the attachment while maintaining the exterior handle at the door opened position, but the operation becomes complicated. In order to solve this problem, an arrangement in which a linking arm part of an exterior handle is engaged with a handle base when the exterior handle is in a door opened state is known from Patent Document 1.

### RELATED ART DOCUMENTS

### Patent Documents

Patent Document 1: Japanese Patent No. 3794291

### DISCLOSURE OF INVENTION

### Problems to be Solved by the Invention

In the arrangement disclosed in Patent Document 1 above, the handle lever is held at the actuated position by engagement between the linking arm part of the exterior handle and the handle base, but the exterior handle is susceptible to an impact, and there is a possibility that the engagement between the linking arm part and the handle base will be released by a small impact or the attachment operation by a worker. Furthermore, for the purpose of facilitating the attachment operation transporting the exterior handle in a state in which it is provisionally held at the door opened position so as to put the handle lever in the actuated position could be considered, but even in this case the engagement might be released by vibration at the time of transport in the engagement structure disclosed in Patent Document 1 above.

The present invention has been accomplished in light of such circumstances, and it is an object thereof to provide a vehicle door exterior handle device that can reliably maintain a state in which an exterior handle is held at a door opened position so as to put a handle lever into an actuated position.

### Means for Solving the Problems

In order to attain the above object, according to a first aspect of the present invention, there is provided a vehicle door exterior handle device in which a handle base having part thereof inserted into an outer panel of a vehicle door through an opening provided in the outer panel blocks the opening and is fixed to the vehicle door, a linking arm part provided on an exterior handle that enables a door opening operation outside the outer panel is inserted into an insertion hole provided in the handle base, the linking arm part being capable of moving between a non-operated position when the exterior handle is in a non-operated state and a door opened position when the exterior handle is in a door opening completed state, a handle lever operatively linked to the linking arm part is supported on the handle base while being capable of pivoting between a non-actuated position corresponding to the non-operated position of the linking arm part and an actuated position corresponding to the door opened position of the linking arm part, the handle lever being resiliently urged toward the non-actuated position side, and insertion of the handle lever into the opening is disabled at the non-actuated position but is allowed at the actuated position when the handle base having attached thereto the handle lever in a state of being operatively linked to the linking arm part is attached to the vehicle door, characterized in that a provisional holding member is mounted on the handle lever, the provisional holding member being capable of rotating around an axis parallel to a pivot axis of the handle lever, and an engagement portion is provided on the provisional holding member, the engagement portion being engaged with a latching part provided on the handle base when the handle lever is at the actuated position.

Further, according to a second aspect of the present invention, in addition to the first aspect, an operating portion is provided on the provisional holding member, the operating portion carrying out engagement of the engagement portion with the latching part and disengagement therefrom.

Furthermore, according to a third aspect of the present invention, in addition to the first or second aspect, the provisional holding member is a bush joint that is resiliently and pivotably fitted into the handle lever while having linked thereto a rod connected to a latch mechanism provided within the vehicle door.

### Effects of the Invention

In accordance with the aspect of the present invention, it is possible, by engaging the engagement portion of the provisional holding member mounted on the handle lever with the latching part of the handle base when the handle lever is at the actuated position, to provisionally hold a state in which the exterior handle is at the door opened position and the handle lever is at the actuated position, thereby facilitating the operation when attaching the exterior handle to the vehicle door. Moreover, since the exterior handle, which is susceptible to an impact, is not itself engaged, the possibility of the provisionally held state being released by impact or vibration at the time of transport can be suppressed.

Furthermore, in accordance with the second aspect of the present invention, since engagement of the engagement portion with the latching part and disengagement therefrom can be carried out by means of the operating portion provided on the provisional holding member, the operation of engaging the engagement portion of the provisional holding member with the latching part of the handle base and disengaging it therefrom is facilitated.

Moreover, in accordance with the third aspect of the present invention, since the provisional holding member is an existing bush joint that is resiliently fitted into the handle lever in order to have linked thereto the rod connected to the latch mechanism within the vehicle door, it is possible by using an existing component to prevent any increase in the number of components.

### BRIEF DESCRIPTION OF DRAWINGS

FIG. 1 is a side view showing part of a vehicle door. (first embodiment)

FIG. 2 is a sectional view along line 2-2 in FIG. 1 when an exterior handle is in a non-operated state. (first embodiment)

FIG. 3 is a perspective view from an outer panel side of the exterior handle in a state in which a handle base and a handle lever at a non-actuated position are assembled. (first embodiment)

FIG. 4 is a perspective view from the outer panel side of the exterior handle in a state in which the handle base and the handle lever at an actuated position are assembled. (first embodiment)

FIG. 5 is a perspective view of a bush joint. (first embodiment)

FIG. 6 is a sectional view along line 6-6 in FIG. 2 comparing a state (a) in which the handle lever is at the non-actuated position and a state (b) in which it is at the actuated position. (first embodiment)

FIG. 7 is an enlarged view of an essential part of FIG. 4. (first embodiment)

FIG. 8 is a perspective view from the direction of arrow 8 in FIG. 7. (first embodiment)

FIG. 9 is a perspective view of an essential part of an exterior handle in which a handle base and a handle lever at a non-actuated position are assembled. (second embodiment)

FIG. 10 is a perspective view, corresponding to FIG. 9, of the exterior handle in a state in which the handle base and the handle lever at an actuated position are assembled. (second embodiment)

FIG. 11 is a perspective view of a bush joint. (second embodiment)

### EXPLANATION OF REFERENCE NUMERALS AND SYMBOLS

11 Outer panel
12 Exterior handle
16 Linking arm part
25, 45 Handle base
26 Opening
29 Insertion hole
36 Handle lever
41, 46 Bush joint, which is a provisional holding member
41d, 46e Engagement portion
41e Operating portion
44, 48 Latching part
42 Rod
43 Latch mechanism
D Vehicle door

### MODES FOR CARRYING OUT THE INVENTION

An embodiment of the present invention is explained below by reference to the attached drawings.

### First Embodiment

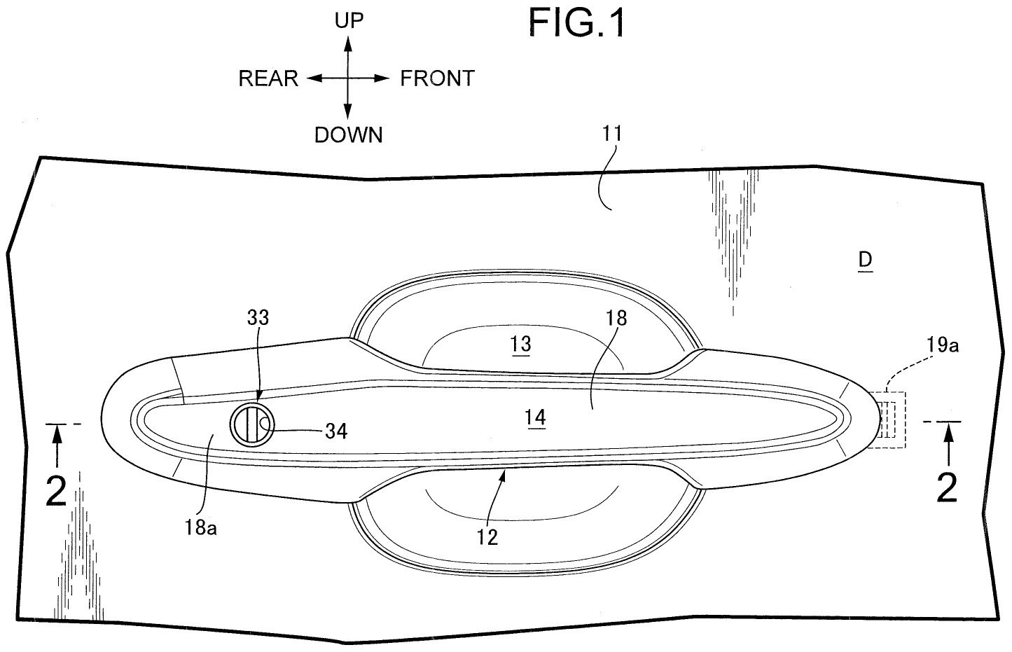

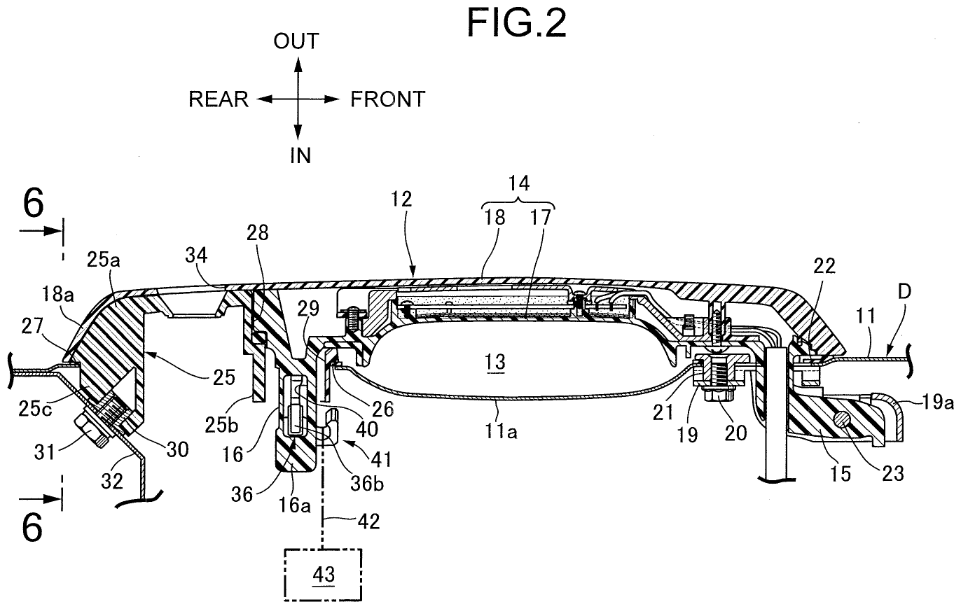

A first embodiment of the present invention is explained by reference to FIG. 1 to FIG. 8. First, in FIG. 1 and FIG. 2, an exterior handle 12 is pivotably mounted on an outer panel 11 of a vehicle door D, for example a side door, the exterior handle 12 extending in the vehicle fore-and-aft direction (the left-and-right direction in FIG. 1) and being capable of being operated on an outer face side of the vehicle door D. A curved portion 11a is provided on the outer panel 11 so as to protrude inward in the vehicle width direction, the curved portion 11a forming a depression 13 that enables the hand of a vehicle user holding the exterior handle 12 outside the outer panel 11 to be inserted thereinto.

The exterior handle 12 has a handle body 14 disposed so as to extend in the vehicle fore-and-aft direction outside the outer panel 11, a substantially L-shaped support arm part 15 connectedly provided on a front end part, in the vehicle fore-and-aft direction, of the handle body 14, and a linking arm part 16 connectedly provided so as to be closer to the other end part of the handle body 14. The handle body 14 is formed from a handle body main part 17 having a substantially U-shaped cross-sectional shape opening on the side opposite to the outer panel 11, and a handle cover 18 covering the handle body main part 17 from the side opposite to the outer panel 11, and the support arm part 15 and the linking arm part 16 are integrally and connectedly provided with the handle body main part 17. Furthermore, the handle cover 18 is formed so as to have a jutting-out portion 18a extending further rearward from a rear end part of the handle body main part 17.

A support member 19 disposed in front of the curved portion 11a in the vehicle fore-and-aft direction is fastened to an inner face of the outer panel 11 by means of a bolt 20 and a nut 21. A thin flat plate-shaped first sheet member 22 is fitted on a front end part of the handle body main part 17 of the handle body 14, the first sheet member 22 being disposed between the front end part and an outer face of the outer panel 11. The support member 19 is provided integrally with a substantially L-shaped bent handle support portion 19a inside the outer panel 11, and the support arm part 15, which extends through the first sheet member 22 and the outer panel 11 and is inserted into the inside of the outer panel 11, is pivotably supported on the handle support portion 19a via a support pin 23.

A handle base 25 is fixed to the vehicle door D, the handle base 25 sandwiching the curved portion 11a between itself and the support member 19. The handle base 25 is formed so as to integrally have a base main portion 25a disposed outside the outer panel 11 so as to block an opening 26 provided in the outer panel 11, a guide portion 25b extending from the base main portion 25a toward the inside of the outer panel 11 so as to guide the linking arm part 16 of the exterior handle 12, and a to-be-mounted portion 25c extending from a rear part of the base main portion 25a to the inside of the outer panel 11. When the exterior handle 12 is at a non-operated position, the base main portion 25a is covered by the jutting-out portion 18a, which juts out rearward from the handle body main part 17, of the handle cover 18 of the handle body 14. A thin flat plate-shaped second sheet member 27 surrounding the opening 26 is disposed between the base main portion 25a and the outer face of the outer panel 11.

A receiving recess 28 is provided in an end part, on the depression 13 side, of the base main portion 25a, the receiving recess 28 receiving a rear end part of the handle body main part 17 of the handle body 14, a rectangular insertion hole 29 is formed in the receiving recess 28, the linking arm part 16 being inserted through the insertion hole 29, and the guide portion 25b is formed into an angular tube and connected to the insertion hole 29.

A nut 30 is press fitted into the to-be-mounted portion 25c, and a bolt 31 is inserted through an end wall 32, on the rear end side, of the vehicle door D, the bolt 31 being screwed into the nut 30. Tightening the bolt 31 fixes the handle base 25 to the vehicle door D.

A cylinder body (not illustrated) of a cylinder lock 33 (see FIG. 1) is fixed to the handle base 25 to the rear of the linking arm part 16, the cylinder lock 33 being locked and unlocked by means of a mechanical key (not illustrated). A through hole 34 is formed in the jutting-out portion 18a of the handle cover 18 of the handle body 14 of the exterior handle 12, the cylinder lock 33 facing the through hole 34.

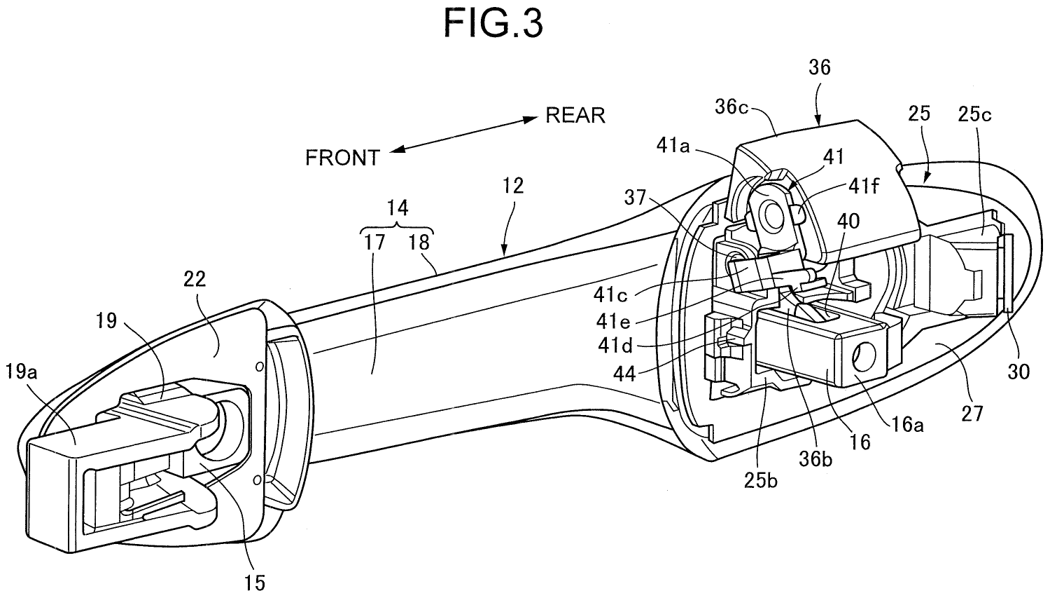

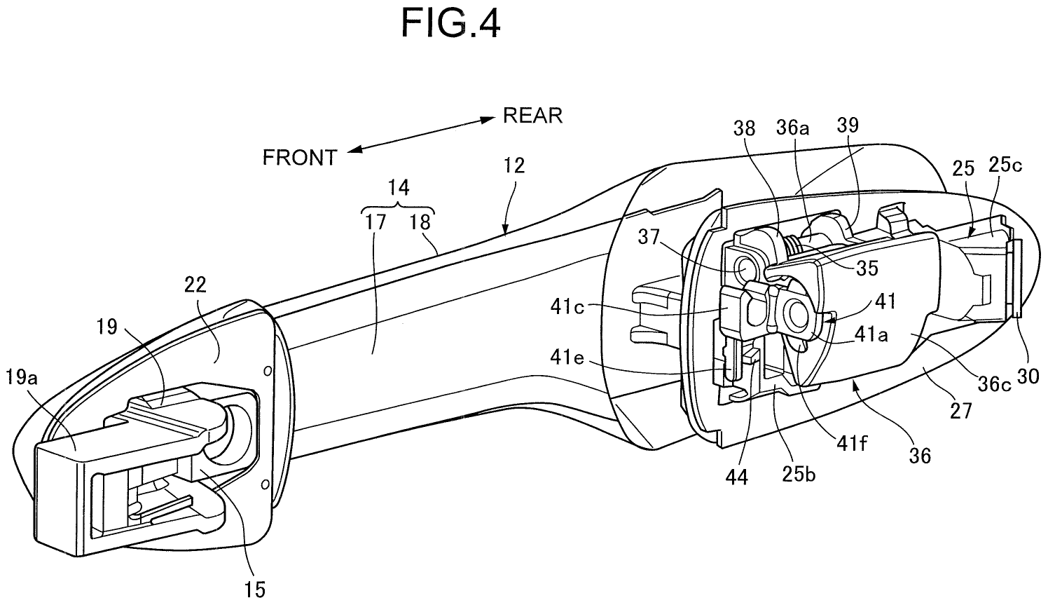

Referring in addition to FIG. 3 and FIG. 4, the linking arm part 16 is inserted into the insertion hole 29 so as to be capable of moving between a non-operated position (position shown in FIG. 2 and FIG. 3) when the exterior handle 12 is in a non-operated state and a door opened position (position shown in FIG. 4) when the exterior handle 12 is in a door opening completed state, and a handle lever 36 is supported on the handle base 25 while being capable of pivoting between a non-actuated position (position shown in FIG. 3) corresponding to the non-operated position of the linking arm part 16 and an actuated position (position shown in FIG. 4) corresponding to the door opened position of the linking arm part 16, the handle lever 36 being operatively linked to the linking arm part 16 and resiliently urged toward the non-actuated position side.

The handle lever 36 is supported on the handle base 25 via a support shaft 37 (see FIG. 4) having an axis along the longitudinal direction of the handle body 14. The support shaft 37 is provided between a pair of support plates 38 and 39 provided integrally with the handle base 25 above the linking arm part 16 while being spaced in the longitudinal direction of the handle body 14.

The handle lever 36 is formed so as to integrally have a support tube portion 36a that is disposed between the support plates 38 and 39 and has the support shaft 37 inserted therethrough, a flat plate-shaped engagement arm portion 36b that is connectedly provided on a portion, close to the support plate 38, of the support tube portion 36a and protrudes in the radially outward direction from the support tube portion 36a, and a weight portion 36c that is connectedly provided on the engagement arm portion 36b, and a torsion spring 35 (see FIG. 4) surrounding the support tube portion 36a is provided between the handle lever 36 and the handle base 25 so as to resiliently urge the handle lever 36 toward the non-actuated position side.

Formed in the linking arm part 16 of the exterior handle 12 is a linking hole 40 that opens on upper and lower sides of the linking arm part 16 and has an end part on the side opposite to the handle body 14 closed by an end wall 16a on the extremity side of the linking arm part 16. The engagement arm portion 36b of the handle lever 36 is inserted into the linking hole 40. The angular tube-shaped guide portion 25b is formed so that an extremity part of the engagement arm portion 36b can be inserted into the linking hole 40.

The extremity part of the engagement arm portion 36b abuts against the extremity side end wall 16a within the linking hole 40, and in response to movement between the non-operated position and the door opened position of the linking arm part 16 accompanying pivoting of the exterior handle 12, the handle lever 36 pivots between the non-actuated position and the actuated position.

A bush joint 41, which is made of an elastic material, is resiliently fitted into the weight portion 36c of the handle lever 36 so that it can pivot around an axis parallel to the axis of the support shaft 37, and one end part of a rod 42 having the other end part linked to the bush joint 41 is linked to a latch mechanism 43 provided within the vehicle door D. That is, due to the handle lever 36 pivoting from the non-actuated position to the actuated position the pressing force from the rod 42 is inputted into the latch mechanism 43.

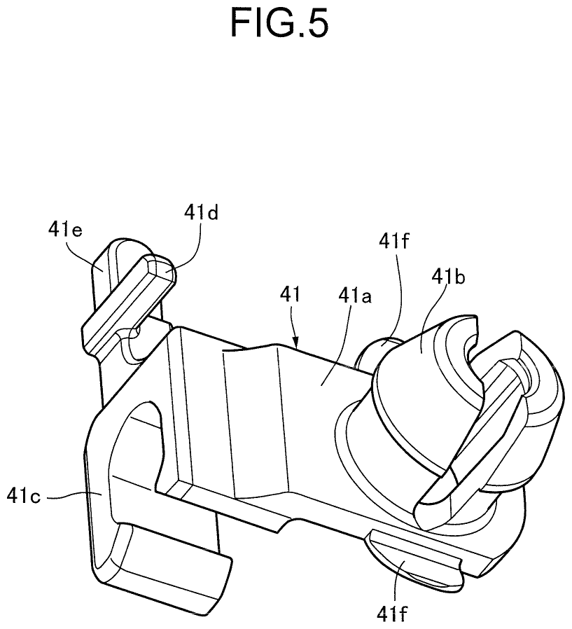

In FIG. 5, the bush joint 41 is formed so as to integrally have a flat plate portion 41a that abuts against a rearward-facing side face of the weight portion 36c of the handle lever 36, a fitting tube portion 41b that is provided so as to project from the flat plate portion 41a so as to be pivotably and resiliently fitted into the weight portion 36c, and a rod linking portion 41c that has a substantially C-shaped form so that an end part of the rod 42 can be inserted through and engaged with the rod linking portion 41c and that is linked to the flat plate portion 41a.

When the intention of a vehicle user to lock the vehicle door D is ascertained, the latch mechanism 43 holds the vehicle door D in a locked state in a state in which a portable apparatus possessed by the vehicle user is ascertained to be legitimate by means of communication between the vehicle and the portable apparatus, and releases the locked state of the vehicle door D in a state in which the portable apparatus possessed by the vehicle user is ascertained to be legitimate by means of communication between the vehicle and the portable apparatus when the intention of the vehicle user to unlock the vehicle door D is ascertained due to the vehicle user holding the handle body 14 in the locked state of the vehicle door D, the vehicle door D in the unlocked state being capable of being opened due to the pressing force from the rod 42 being inputted to the latch mechanism 43.

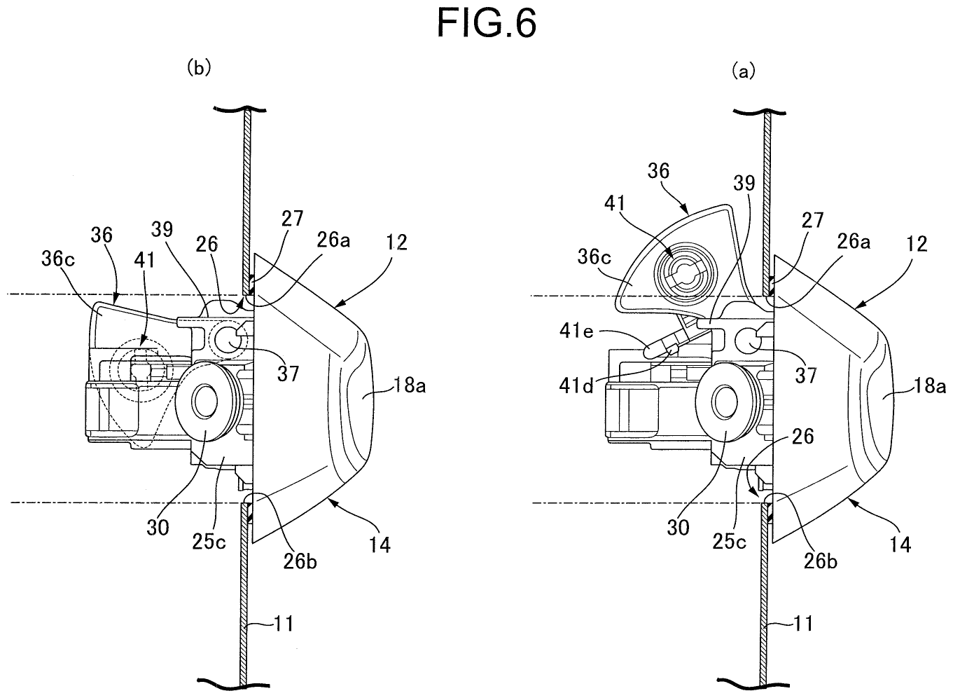

When the handle lever 36 is at the non-actuated position, as shown in FIG. 6 (a), the weight portion 36c of the handle lever 36 protrudes further upward than an upper edge 26a of the opening 26 of the outer panel 11, and in this state the handle lever 36 cannot be inserted through the opening 26 as it is when attaching to the vehicle door D the handle base 25 having attached thereto the handle lever 36 operatively linked to the linking arm part 16 of the exterior handle 12; as shown in FIG. 6 (b), when the handle lever 36 is at the actuated position, the weight portion 36c of the handle lever 36 is within the width between the upper edge 26a and a lower edge 26b of the opening 26 of the outer panel 11, and by so doing the handle lever 36 can be inserted through the opening 26 as it is when attaching to the vehicle door D the handle base 25 having attached thereto the handle lever 36 operatively linked to the linking arm part 16 of the exterior handle 12.

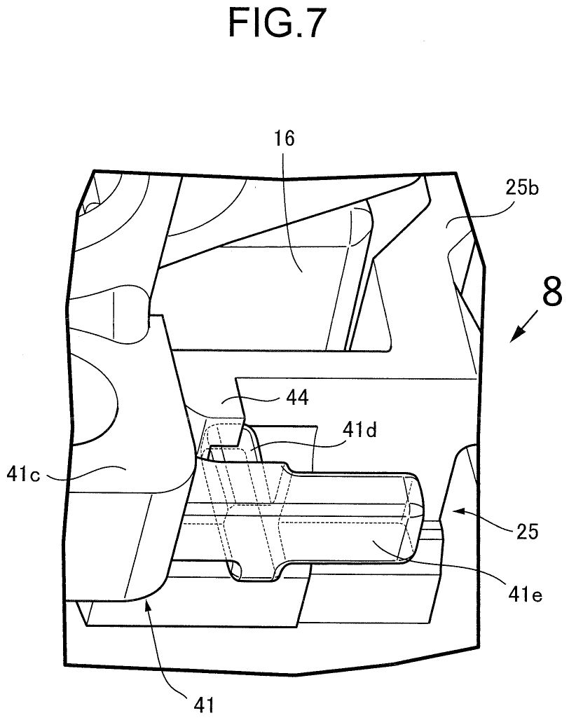

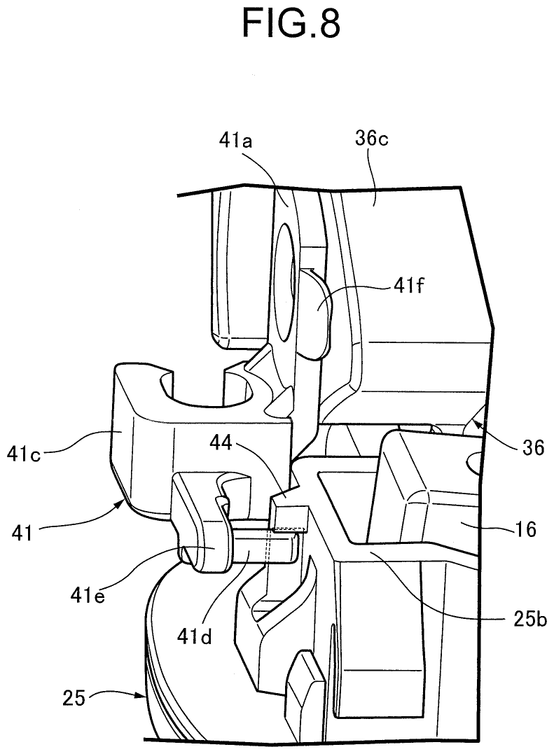

As is clearly shown in FIG. 7 and FIG. 8, an engagement portion 41d is provided on the bush joint 41, which is mounted on the handle lever 36 as a provisional holding member that can rotate around an axis parallel to the pivot axis of the handle lever 36, the engagement portion 41d detachably engaging with a latching part 44 provided on the handle base 25 when the handle lever 36 is at the actuated position.

The latching part 44 is projectingly provided integrally with the guide portion 25b of the handle base 25 so as to project forward in the vehicle fore-and-aft direction, and the engagement portion 41d can move over the latching part 44 and engage with the latching part 44 from the handle body 14 side in a state in which the handle lever 36 pivots from the non-actuated position to the actuated position. An operation portion 41e is provided on the bush joint 41, the operation portion 41e being for carrying out engagement of the engagement portion 41d with the latching part 44 and disengagement therefrom. That is, the operating portion 41e is connectedly provided on the rod linking portion 41c so as to extend linearly within a plane orthogonal to the axis of the fitting tube portion 41b, the engagement portion 41d is connectedly provided at right angles on an intermediate part of the operating portion 41e, and flexing the operating portion 41e enables the engagement portion 41d to be made to go over the latching part 44 and be engaged with the latching part 44.

A pair of ear portions 41f disposed on opposite sides of the fitting tube portion 41b are connectedly provided integrally with the flat plate portion 41a of the bush joint 41, and these ear portions 41f make resilient contact with the weight portion 36c of the handle lever 36 on opposite sides of the fitting tube portion 41b, thereby suppressing rattling of the bush joint 41.

The operation of the first embodiment is now explained; since the bush joint 41 as a provisional holding member that can rotate around an axis parallel to the pivot axis of the handle lever 36 is mounted on the handle lever 36, and the engagement portion 41d, which is engaged with the latching part 44 provided on the handle base 25 when the handle lever 36 is at the actuated position, is provided on the bush joint 41, a state in which the exterior handle 12 is at the door opened position and the handle lever 36 is at the actuated position can be provisionally held, and the operation of attaching the exterior handle 12 to the vehicle door D is facilitated. Moreover, since the exterior handle 12, which is susceptible to an impact, is not itself engaged, the possibility of the provisionally held state being released by impact or vibration at the time of transport can be suppressed.

Furthermore, since the operation portion 41e, which is for carrying out engagement of the engagement portion 41d with the latching part 44 and disengagement therefrom, is provided on the bush joint 41, the operation of engaging the engagement portion 41d of the bush joint 41 with the latching part 44 of the handle base 25 and disengaging it therefrom is facilitated.

Moreover, since the bush joint 41 is pivotably and resiliently fitted into the handle lever 36 while having linked thereto the rod 42 connected to the latch mechanism 43 provided within the vehicle door D and is an existing component, it is possible by using an existing component to prevent any increase in the number of components.

### Second Embodiment

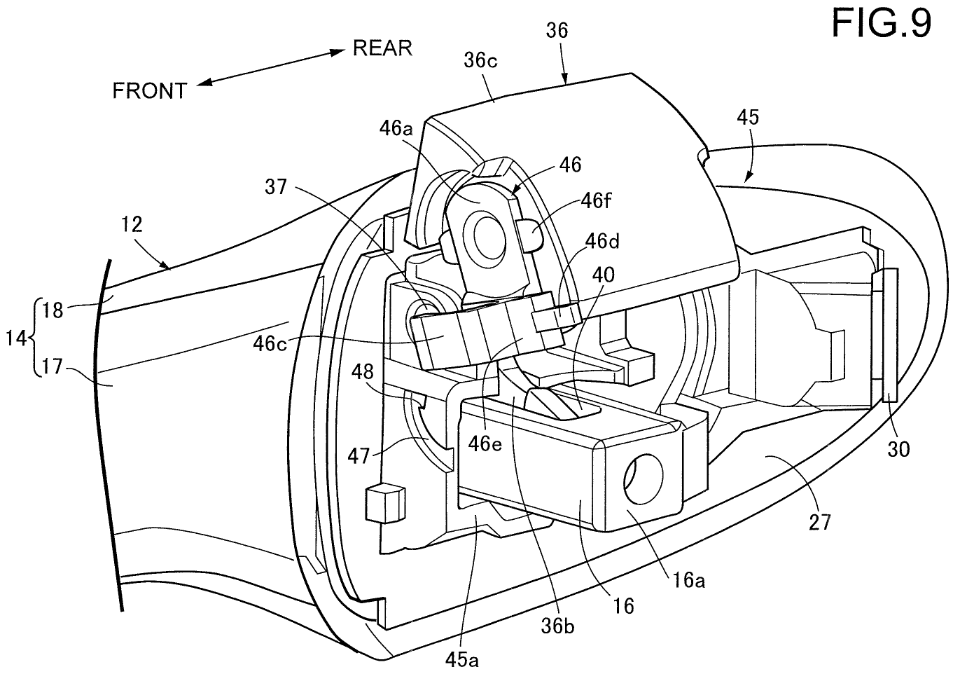

A second embodiment of the present invention is explained by reference to FIG. 9 to FIG. 11, portions corresponding to those of the first embodiment being denoted by the same reference numerals and symbols and detailed explanation thereof being omitted.

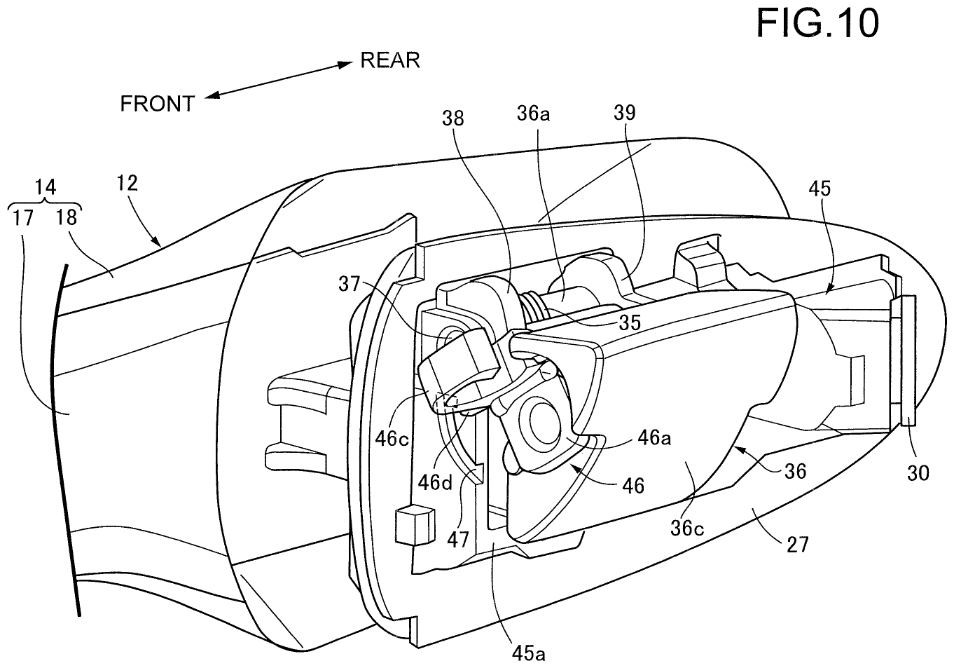

First, in FIG. 9 and FIG. 10, the handle lever 36 is supported on a handle base 45 via the support shaft 37 having an axis along the longitudinal direction of the handle body 14 of the exterior handle 12. The extremity part of the engagement arm portion 36b of the handle lever 36 is inserted into the linking hole 40 formed in the linking arm part 16 of the exterior handle 12, and in response to movement between the non-operated position and the door opened position of the linking arm part 16 accompanying pivoting of the exterior handle 12 the handle lever 36 pivots between the non-actuated position and the actuated position.

A bush joint 46 that is made of an elastic material is resiliently fitted into the weight portion 36c of the handle lever 36 so that it can pivot around an axis parallel to the axis of the support shaft 37. One end part of the rod 42 having the other end part linked to the bush joint 46 is linked to the latch mechanism 43 (see first embodiment).

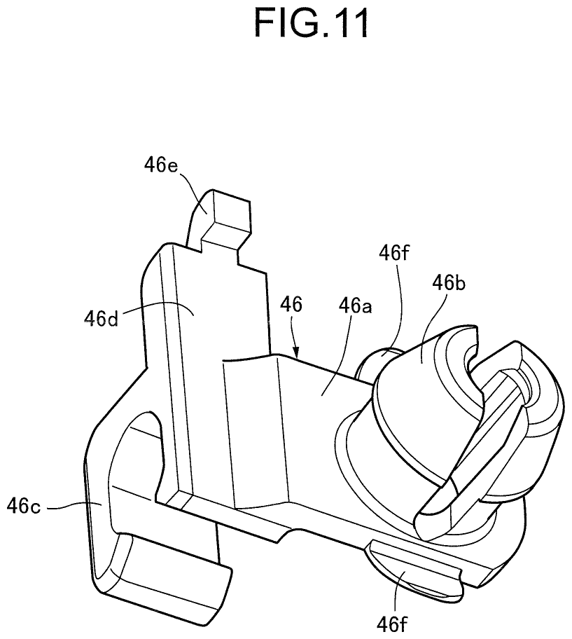

Referring in addition to FIG. 11, the bush joint 46 that can rotate around an axis parallel to the pivot axis of the handle lever 36 is mounted on the handle lever 36 as a provisional holding member. This bush joint 46 is formed so as to integrally have a flat plate portion 46a that abuts against a rearward-facing side face of the weight portion 36c of the handle lever 36, a fitting tube portion 46b that is provided so as to project from the flat plate portion 46a so as to be pivotably and resiliently fitted into the weight portion 36c, a rod linking portion 46c that has a substantially C-shaped form so that an end part of the rod 42 can be inserted through and engaged with the rod linking portion 41c and that is connected to the flat plate portion 41a, a projecting portion 46d that projects from an end part, on the flat plate portion 46a side, of the rod linking portion 46c to the side opposite to the opening side of the rod linking portion 46c, and an engagement portion 46e that projects from an extremity part of the projecting portion 46d so that it can detachably engage with a latching part 48 provided on the handle base 45 when the handle lever 36 is at the actuated position.

A pair of ear portions 46f disposed on opposite sides of the fitting tube portion 46b are connectedly provided on the flat plate portion 46a of the bush joint 46, and these ear portions 46f make resilient contact with the weight portion 36c of the handle lever 36 on opposite sides of the fitting tube portion 46b, thereby suppressing rattling of the bush joint 46.

Furthermore, the engagement portion 46e projects from a middle part in the width direction of the extremity part of the projecting portion 46d along a direction in which the projecting portion 46d projects and is formed into a substantially L-shaped cross-sectional shape.

A guide groove 47 is formed in an outer face of a guide portion 45a provided integrally with the handle base 45 so as to guide the linking arm part 16 of the exterior handle 12, the guide groove 47 carrying out guiding by slightly flexing an extremity part of the engagement portion 46e of the bush joint 46 and making sliding contact therewith when pivoting the bush joint 46 around the axis of its fitting tube portion 46b while the handle lever 36 is at the actuated position. This guide groove 47 is formed into an arc shape with the axis of the fitting tube portion 46b of the bush joint 46 as the center when the handle lever 36 is at the actuated position.

Moreover, the latching part 48 is provided on an intermediate part of the guide groove 47 so as to form a step, an extremity part of the engagement portion 46e of the bush joint 46 engaging with the latching part 48, and letting the bush joint 46 go in a state in which the engagement portion 46e is pivoted so as to slide within the guide groove 47 while slightly flexing it enables the engagement portion 46e to be engaged with the latching part 48, thereby holding the handle lever 36 at the actuated position.

In accordance with the second embodiment, a state in which the exterior handle 12 is at the door opened position and the handle lever 36 is at the actuated position can also be provisionally held, and the operation of attaching the exterior handle 12 to the vehicle door D (see the first embodiment) is facilitated. Moreover, since the exterior handle 12, which is susceptible to an impact, is not itself engaged, the possibility of the provisionally held state being released by impact or vibration at the time of transport can be suppressed.

Embodiments of the present invention are explained above, but the present invention is not limited to the embodiments and may be modified in a variety of ways as long as the modifications do not depart from the spirit and scope thereof.

1. A vehicle door exterior handle device in which a handle base having part thereof inserted into an outer panel of a vehicle door through an opening provided in the outer panel blocks the opening and is fixed to the vehicle door, a linking arm part provided on an exterior handle that enables a door opening operation outside the outer panel is inserted into an insertion hole provided in the handle base, the linking arm part being capable of moving between a non-operated position when the exterior handle is in a non-operated state and a door opened position when the exterior handle is in a door opening completed state, a handle lever operatively linked to the linking arm part is supported on the handle base while being capable of pivoting between a non-actuated position corresponding to the non-operated position of the linking arm part and an actuated position corresponding to the door opened position of the linking arm part, the handle lever being resiliently urged toward the non-actuated position side, and insertion of the handle lever into the opening is disabled at the non-actuated position but is allowed at the actuated position when the handle base having attached thereto the handle lever in a state of being operatively linked to the linking arm part is attached to the vehicle door, wherein a provisional holding member is mounted on the handle lever, the provisional holding member being capable of rotating around an axis parallel to a pivot axis of the handle lever, and an engagement portion is provided on the provisional holding member, the engagement portion being engaged with a latching part provided on the handle base when the handle lever is at the actuated position.

2. The vehicle door exterior handle device according to claim 1, wherein an operating portion is provided on the provisional holding member, the operating portion carrying out engagement of the engagement portion with the latching part and disengagement therefrom.

3. The vehicle door exterior handle device according to claim 1, wherein the provisional holding member is a bush joint that is resiliently and pivotably fitted into the handle lever while having linked thereto a rod connected to a latch mechanism provided within the vehicle door.

4. The vehicle door exterior handle device according to claim 2, wherein the provisional holding member is a bush joint that is resiliently and pivotably fitted into the handle lever while having linked thereto a rod connected to a latch mechanism provided within the vehicle door.
